(19) United States
(12) Patent Application Publication
(10) Pub. No.: US 2020/0183762 A1
(43) Pub. Date: Jun. 11, 2020

(54) SIMULATION DISTRACTION SUPPRESSION

(71) Applicant: INTERNATIONAL BUSINESS MACHINES CORPORATION, Armonk, NY (US)

(72) Inventors: Robert E. Loredo, North Miami Beach, FL (US); Paul R. Bastide, Boxford, MA (US); Matthew E. Broomhall, Goffstown, NH (US); Sathya Srini, Cambridge, MA (US)

(21) Appl. No.: 16/212,672

(22) Filed: Dec. 6, 2018

(51) Int. Cl. G06F 9/54; G06F 1/16; G06T 19/00; G06F 3/01; H04L 12/58; G06F 16/9032; G06F 16/901

(52) U.S. Cl. CPC G06F 9/542; G06F 1/163; G06T 19/006; G06F 16/9017; H04L 51/24; G06F 16/90332; G06F 3/011

(57) ABSTRACT

The urgency of a message received for a user engaging in a computer-generated simulation is determined in response to receipt of the message. The user can be notified of receipt of the message using a simulated notifying object that is consistent with an ambience of the simulation. The notifying object can be selected based on the urgency of the message.

### BACKGROUND

The present disclosure relates to the field of computer-based systems, and more particularly, to computer-generated simulations such as virtual reality and augmented reality renderings using a computer.

Computer-generated simulations can create an artificial environment that seemingly duplicates a real-world environment or an artificial one far removed from the real world. Computer-generated simulations thus can provide varied experiences to a user. Computer-generated virtual reality, for example, creates a simulated environment in which the user experiences images, sounds, and sensations with which the user can interact as though in a real-world physical environment. Somewhat relatedly, augmented reality is an interactive environment in which real-world objects are augmented by computer-generated images, sounds, and sensations. While many computer simulations provide enjoyment and entertainment, many simulations serve other purposes, such as education and training.

### SUMMARY

A method includes responding to the receiving of a message for a user engaging in a computer-generated simulation. The method can include determining, using computer hardware, the urgency of the message. The method can also include notifying the user of the message using a simulated notifying object that is consistent with the ambience of the simulation. The notifying object can be selected based on the urgency of the message.

A system includes a processor programmed to initiate executable operations. The operations can include responding to the receiving of a message for a user engaging in a computer-generated simulation. Additionally, the operations can include determining the urgency of the message. The message can also include notifying the user of the message using a simulated notifying object that is consistent with the ambience of the simulation. The notifying object can be selected based on the urgency of the message.

A computer program product includes a computer readable storage medium on which is stored program code. The program code is executable by a data processing system to initiate operations that include responding to the receiving of a message for a user engaging in a computer-generated simulation. The operations can include determining the urgency of the message. The operations can also include notifying the user of the message using a simulated notifying object that is consistent with the ambience of the simulation. The notifying object can be selected based on the urgency of the message.

### BRIEF DESCRIPTION OF THE DRAWINGS

FIG. 1 depicts a cloud computing environment according to an embodiment of the present invention.

FIG. 2 depicts abstraction model layers according to an embodiment of the present invention.

FIG. 3 depicts a cloud computing node according to an embodiment of the present invention.

FIG. 4 depicts an environment in which a system for mitigating messaging distractions during a simulation can be implemented according to an embodiment of the present invention.

FIG. 5 depicts a message-simulation interface tool for mitigating messaging distractions during a simulation according to an embodiment of the present invention.

FIG. 6 depicts a look-up table used in a system for mitigating messaging distractions during a simulation according to an embodiment of the present invention.

FIG. 7 is a flowchart of a method of mitigating messaging distractions during a simulation according to another embodiment of the present invention.

FIG. 8 is a flowchart of a method of mitigating messaging distractions during a simulation according to another embodiment of the present invention.

FIG. 9 is a flowchart of a method of mitigating messaging distractions during a simulation according to still another embodiment of the present invention.

FIG. 10 is a flowchart of a method of mitigating messaging distractions during a simulation according to still another embodiment of the present invention.

### DETAILED DESCRIPTION

The present disclosure relates to computer-generated simulators that create artificial environments that simulate real or fanciful environments in which a user can interact with the environment as though physically present therein.

The more immersive the artificial environment, the greater the degree to which a user may be divorced from the real world. Although this is typically the intended effect of the simulation, there nevertheless are circumstances in which the user needs or would wish to know that while engaged in the simulated environment, a real-world message for the user has arrived. Some messages are of little or no urgency, while others demand immediate attention. Many messages likely fall somewhere between these two extremes. Notification that a message is waiting, however, is likely to break the user's concentration. If a user is engaged in a simulation for enjoyment or relaxation, an overly obtrusive intrusion announcing a message is likely to be frustrating or, at the least, annoying. If the user is engaged in a training simulation, it may be necessary to announce a message (e.g., use-time set to expire or other users waiting). Doing so too starkly, though, can unnecessarily undermine the intended training experience. If the simulation is being used for testing, a message indicating for example that the test is soon set to end can be helpful to the user, but the message may destroy the validity of the test if unduly distracting to the user's concentration.

The present disclosure describes methods, systems, and computer program products for suppressing distraction in notifying a simulator user that a message for the user has been received while the user is engaged in a simulation. The simulator can be any type of device (e.g., virtual or augmented reality headset, educational simulator, or training simulator) capable of generating images, sounds, or other effects (e.g., using a haptic feedback device). The simulator creates a simulated environment by presenting coherent images and sounds, purposely rather than randomly selected to be consistent with the ambience of the specific environment being simulated. For example, in a day-at-the-beach simulation a coherent collection of images and sounds can include the sight of waves in the distance and the sound of waves crashing on the shore. Depending on the simulator's capabilities, other simulated effects can be generated that are also perceived by the user's other physical senses. For example, in the beach simulation, a haptic feedback device can be used to create the sensation of a sea breeze. These sights, sounds, and sensations are purposely selected to be consistent with the ambience of the beach environment.

The methods, systems, and computer program products described herein notify a simulator user that a message for the user has been received while the user is engaging in a simulation. The urgency of the message may be determined in response to the message being received. The user is notified using a simulated object, the notifying object, consistent with an ambience of the simulation. The notifying object may be selected based on the urgency of the message. The notifying object also can be presented to the user in a manner that is likewise consistent with the ambience.

The various embodiments of the methods, systems and computer program products disclosed provide improved message handling for all types of simulators and with respect to all types of computer-generated simulations. Message notification and content can be presented to and processed by a user while the user remains engaged in a simulation. Notification and content are presented to the user in a manner that reveals the message's urgency but without undue intrusion into the flow and presentment of the simulation. The result is a more efficient communication system and a better simulation experience. The result is also an improved interface between communication systems and simulators. For example, a simulation need not be interrupted and restarted unnecessarily, and yet, there is not an additional risk of missing an important communication. There is also reduced risk of unnecessary distractions that otherwise detract from the user's simulation experience.

The methods, systems, and computer programs also provide a more efficient and effective user interface. By ascertaining message criticality and presenting notifications and/or message content in manner consistent with the simulation ambience, a user is not inundated with messages that do not warrant interrupting the simulation experience. The user is also better able to process received messages that are consistent with the ambience of the simulation in which the user is engaged.

It is understood in advance that although this disclosure includes a detailed description on cloud computing, implementation of the teachings recited herein are not limited to a cloud computing environment. Rather, embodiments of the present invention are capable of being implemented in conjunction with any other type of computing environment now known or later developed.

Cloud computing is a model of service delivery for enabling convenient, on-demand network access to a shared pool of configurable computing resources (e.g. networks, network bandwidth, servers, processing, memory, storage, applications, virtual machines, and services) that can be rapidly provisioned and released with minimal management effort or interaction with a provider of the service. This cloud model may include at least five characteristics, at least three service models, and at least four deployment models.

Characteristics are as Follows:

On-demand self-service: a cloud consumer can unilaterally provision computing capabilities, such as server time and network storage, as needed automatically without requiring human interaction with the service's provider.

Broad network access: capabilities are available over a network and accessed through standard mechanisms that promote use by heterogeneous thin or thick client platforms (e.g., mobile phones, laptops, and PDAs).

Resource pooling: the provider's computing resources are pooled to serve multiple consumers using a multi-tenant model, with different physical and virtual resources dynamically assigned and reassigned according to demand. There is a sense of location independence in that the consumer generally has no control or knowledge over the exact location of the provided resources but may be able to specify location at a higher level of abstraction (e.g., country, state, or datacenter).

Rapid elasticity: capabilities can be rapidly and elastically provisioned, in some cases automatically, to quickly scale out and rapidly released to quickly scale in. To the consumer, the capabilities available for provisioning often appear to be unlimited and can be purchased in any quantity at any time.

Measured service: cloud systems automatically control and optimize resource use by leveraging a metering capability at some level of abstraction appropriate to the type of service (e.g., storage, processing, bandwidth, and active user accounts). Resource usage can be monitored, controlled, and reported providing transparency for both the provider and consumer of the utilized service.

Service Models are as Follows:

Software as a Service (SaaS): the capability provided to the consumer is to use the provider's applications running on a cloud infrastructure. The applications are accessible from various client devices through a thin client interface such as a web browser (e.g., web-based e-mail). The consumer does not manage or control the underlying cloud infrastructure including network, servers, operating systems, storage, or even individual application capabilities, with the possible exception of limited user-specific application configuration settings.

Platform as a Service (PaaS): the capability provided to the consumer is to deploy onto the cloud infrastructure consumer-created or acquired applications created using programming languages and tools supported by the provider. The consumer does not manage or control the underlying cloud infrastructure including networks, servers, operating systems, or storage, but has control over the deployed applications and possibly application hosting environment configurations.

Infrastructure as a Service (IaaS): the capability provided to the consumer is to provision processing, storage, networks, and other fundamental computing resources where the consumer is able to deploy and run arbitrary software, which can include operating systems and applications. The consumer does not manage or control the underlying cloud infrastructure but has control over operating systems, storage, deployed applications, and possibly limited control of select networking components (e.g., host firewalls).

Deployment Models are as Follows:

Private cloud: the cloud infrastructure is operated solely for an organization. It may be managed by the organization or a third party and may exist on-premises or off-premises.

Community cloud: the cloud infrastructure is shared by several organizations and supports a specific community that has shared concerns (e.g., mission, security requirements, policy, and compliance considerations). It may be managed by the organizations or a third party and may exist on-premises or off-premises.

Public cloud: the cloud infrastructure is made available to the general public or a large industry group and is owned by an organization selling cloud services.

Hybrid cloud: the cloud infrastructure is a composition of two or more clouds (private, community, or public) that remain unique entities but are bound together by standardized or proprietary technology that enables data and application portability (e.g., cloud bursting for load-balancing between clouds).

A cloud computing environment is service oriented with a focus on statelessness, low coupling, modularity, and semantic interoperability. At the heart of cloud computing is an infrastructure comprising a network of interconnected nodes.

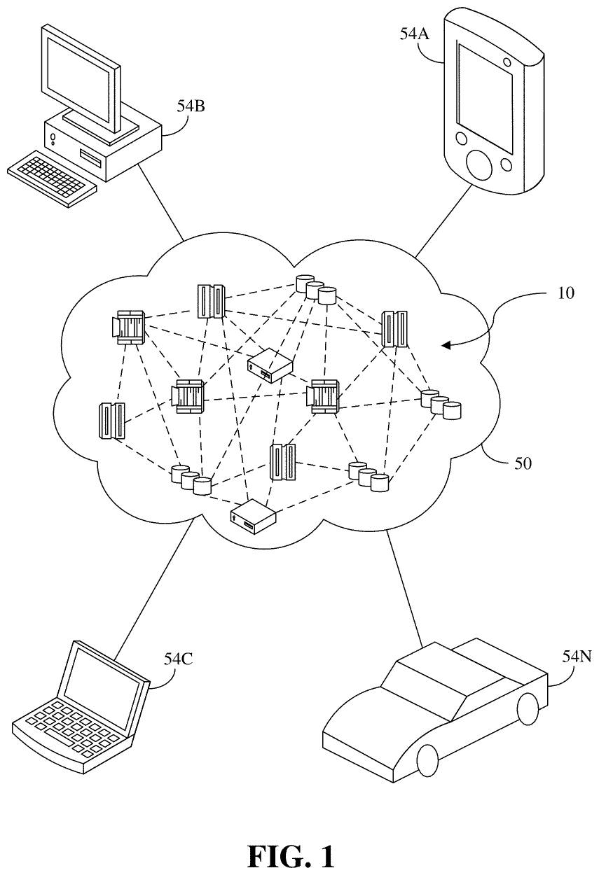

Referring now to FIG. 1, illustrative cloud computing environment 50 is depicted. As shown, cloud computing environment 50 includes one or more cloud computing nodes 10 with which local computing devices used by cloud consumers, such as, for example, personal digital assistant (PDA) or cellular telephone 54A, desktop computer 54B, laptop computer 54C, and/or automobile computer system 54N may communicate. Nodes 10 may communicate with one another. They may be grouped (not shown) physically or virtually, in one or more networks, such as Private, Community, Public, or Hybrid clouds as described hereinabove, or a combination thereof. This allows cloud computing environment 50 to offer infrastructure, platforms and/or software as services for which a cloud consumer does not need to maintain resources on a local computing device. It is understood that the types of computing devices 54A-N shown in FIG. 1 are intended to be illustrative only and that computing nodes 10 and cloud computing environment 50 can communicate with any type of computerized device over any type of network and/or network addressable connection (e.g., using a web browser).

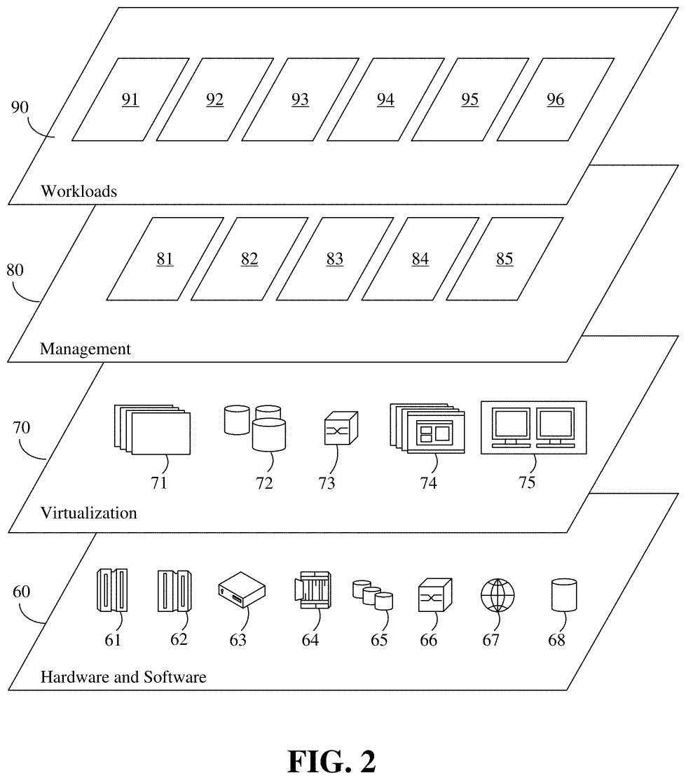

Referring now to FIG. 2, a set of functional abstraction layers provided by cloud computing environment 50 (FIG. 1) is shown. It should be understood in advance that the components, layers, and functions shown in FIG. 2 are intended to be illustrative only and embodiments of the invention are not limited thereto. As depicted, the following layers and corresponding functions are provided:

Hardware and software layer 60 includes hardware and software components. Examples of hardware components include: mainframes 61; RISC (Reduced Instruction Set Computer) architecture based servers 62; servers 63; blade servers 64; storage devices 65; and networks and networking components 66. In some embodiments, software components include network application server software 67 and database software 68.

Virtualization layer 70 provides an abstraction layer from which the following examples of virtual entities may be provided: virtual servers 71; virtual storage 72; virtual networks 73, including virtual private networks; virtual applications and operating systems 74; and virtual clients 75.

In one example, management layer 80 may provide the functions described below. Resource provisioning 81 provides dynamic procurement of computing resources and other resources that are utilized to perform tasks within the cloud computing environment. Metering and Pricing 82 provide cost tracking as resources are utilized within the cloud computing environment, and billing or invoicing for consumption of these resources. In one example, these resources may include application software licenses. Security provides identity verification for cloud consumers and tasks, as well as protection for data and other resources. User portal 83 provides access to the cloud computing environment for consumers and system administrators. Service level management 84 provides cloud computing resource allocation and management such that required service levels are met. Service Level Agreement (SLA) planning and fulfillment 85 provide pre-arrangement for, and procurement of, cloud computing resources for which a future requirement is anticipated in accordance with an SLA. Workloads layer 90 provides examples of functionality for which the cloud computing environment may be utilized. Examples of workloads and functions which may be provided from this layer include: mapping and navigation 91; software development and lifecycle management 92; virtual classroom education delivery 93; data analytics processing 94; transaction processing 95; and a system 96 for mitigating messaging distractions during a simulation.

In one or more embodiments, system 96 is capable of notifying a simulator user that a message for the user has been received while the user is engaged in a simulation. The system presents the notification using a simulated notifying object that is consistent with the ambience of the simulation. The system can determine the urgency of the received message and select the notifying object based on the urgency. Actions of the notifying object can be simulated in a manner consistent with the ambience of the simulation. The actions of the notifying object in presenting the notification or content of a message can be selected based on the urgency of the message.

In different embodiments, system 96 can be implemented in processor-executable code that runs on the processor of a simulator or other environment-creating device. In other embodiments, system 96 can be implemented in dedicated, hardwired circuitry integrated in circuitry present in a simulator or similar such device. In still other embodiments, system 96 can be implemented as a combination of processor-executable code and circuitry.

System 96 can operate in various computing environments. For example, the system can operate as a stand-alone gaming device or console. The system can, for example, operate on a network-connected device. Such a networked device can be, for example, a cloud computing node.

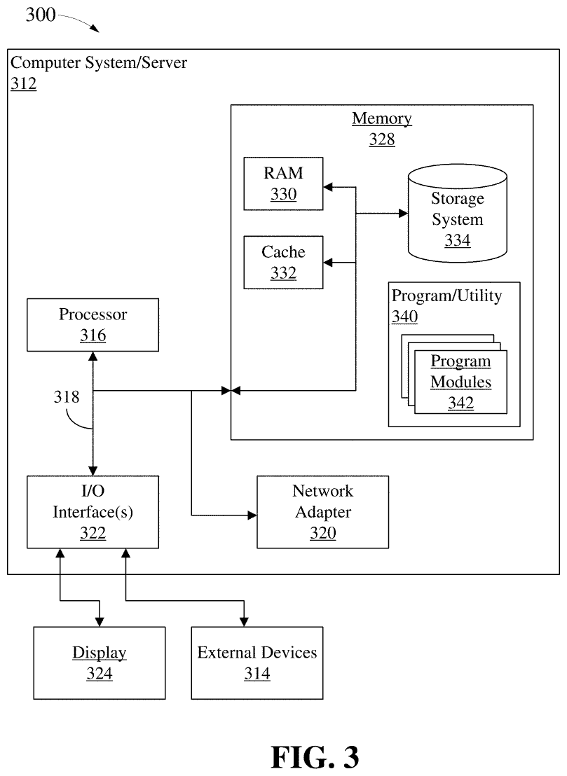

Referring now to FIG. 3, a schematic of an example of a cloud computing node is shown. Cloud computing node 300 is only one example of a suitable cloud computing node and is not intended to suggest any limitation as to the scope of use or functionality of embodiments of the invention described herein. Regardless, cloud computing node 300 is capable of being implemented and/or performing any of the functionality set forth hereinabove.

Cloud computing node 300 includes a computer 312, which is operational with numerous other general-purpose or special-purpose computing system environments or configurations. Examples of well-known computing systems, environments, and/or configurations that may be suitable for use with computer 312 include, but are not limited to, personal computers, servers, thin clients, thick clients, hand-held or laptop devices, multiprocessor systems, microprocessor-based systems, set top boxes, programmable consumer electronics, network PCs, minicomputers, mainframe computers, and distributed cloud computing environments that include any of the above systems or devices, and the like.

Computer 312 may be described in the general context of computer system-executable instructions, such as program modules, being executed by a computer or computing system. Generally, program modules may include routines, programs, objects, components, logic, data structures, and so on that perform particular tasks or implement particular abstract data types. Computer 312 may be practiced in distributed cloud computing environments where tasks are performed by remote processing devices that are linked through a communications network. In a distributed cloud computing environment, program modules may be located in both local and remote computer system storage media including memory storage devices.

As shown in FIG. 3, computer 312 in cloud computing node 300 is shown in the form of a general-purpose computing device. The components of computer 312 may include, but are not limited to, one or more processors 316, a memory 328, and a bus 318 that couples various system components including memory 328 to processor 316.

Bus 318 represents one or more of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus.

Computer 312 typically includes a variety of computer-readable media. Such media may be any available media that is accessible by computer 312, and includes both volatile and non-volatile media, removable and non-removable media.

Memory 328 can include computer-readable media in the form of volatile memory, such as random-access memory (RAM) 330 and/or cache memory 332. Computer 312 may further include other removable/non-removable, volatile/non-volatile computer storage media. By way of example, storage system 334 can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 318 by one or more data media interfaces. As will be further depicted and described below, memory 328 may include at least one program product having a set (e.g., at least one) of program modules that are configured to carry out the functions of embodiments disclosed.

Program/utility 340, having a set (at least one) of program modules 342, may be stored in memory 328 by way of example, and not limitation, as well as an operating system, one or more application programs, other program modules, and program data. Each of the operating system, one or more application programs, other program modules, and program data or some combination thereof, may include an implementation of a networking environment. Program modules 342 generally carry out the functions and/or methodologies of embodiments of the embodiments described herein.

For example, one or more of the program modules may include system 96 or portions thereof. Program/utility 340 is executable by processor 316. Program/utility 340 and any data items used, generated, and/or operated upon by node 300 are functional data structures that impart functionality when employed by node 300. As defined within this disclosure, a “data structure” is a physical implementation of a data model's organization of data within a physical memory. As such, a data structure is formed of specific electrical or magnetic structural elements in a memory. A data structure imposes physical organization on the data stored in the memory as used by an application program executed using a processor.

Computer 312 may also communicate with one or more external devices 314 such as a keyboard, a pointing device, a display 324, etc.; one or more devices that enable a user to interact with computer 312; and/or any devices (e.g., network card, modem, etc.) that enable computer 312 to communicate with one or more other computing devices. Such communication can occur via Input/Output (I/O) interfaces 322. Computer 312 can communicate with one or more networks such as a local area network (LAN), a general wide area network (WAN), and/or a public network (e.g., the Internet) via network adapter 320. As depicted, network adapter 320 communicates with the other components of computer 312 via bus 318. It is emphasized that although not shown, other hardware and/or software components could be used in conjunction with computer 312. Examples include, but are not limited to, the following: microcode, device drivers, redundant processing units, external disk drive arrays, RAID systems, tape drives, and data archival storage systems.

While node 300 is used to illustrate an example of a cloud computing node, it should be appreciated that a computer system using an architecture the same as or similar to that shown in FIG. 3 may be used in a non-cloud computing implementation to perform the various operations described herein. In this regard, the example embodiments described herein are not intended to be limited to a cloud computing environment.

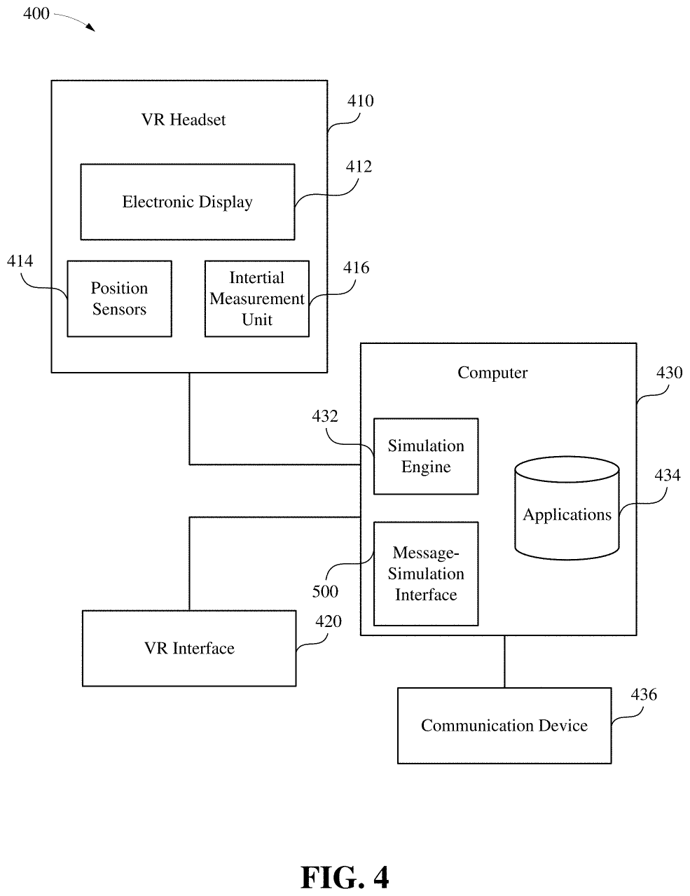

Referring additionally now to FIG. 4, an environment 400 in which system 96 can be implemented is depicted. Illustratively, environment 400 includes a virtual reality (VR) headset 410 and VR interface 420, both of which are communicatively coupled to computer 430. VR headset 410 illustratively includes electronic display 412, one or more motion sensors 414, and inertial measurement unit (IMU) 416.

VR headset 410 presents media in various forms including images, video, audio, and any combination thereof to a system user through electronic display 412. Though not explicitly shown, headset 410 also can include earphones or speakers for rendering audio in conjunction with visual displays. Motion sensors 414 generate measurement signals in response to sensing the motions of the headset. The signals are conveyed to IMU 416, which can comprise one or more accelerometers, as well as one or more gyroscopes. IMU 416 generates motion data based on the signals received from motion sensors 414 and conveys the data to computer 430.

VR interface 420 conveys action requests from a user to computer 430 and can include one or more devices, including sensory feedback devices, for simulating interactions within the simulated environment. Actions requested can initiate or stop a reality-rendering application or cause the performance of a simulated action.

Computer 430 illustratively includes a simulation engine 432 and applications database 434. Simulation engine 432 determines which media is conveyed to the VR headset 410 for presentment to the user. Simulation engine 432 performs actions within applications executing on the computer in response to action requests received from the VR interface 420 and provides feedback to the user. Feedback can be visual or audio feedback that is conveyed to the user with VR headset 410. Other feedback, such as haptic feedback, can be conveyed to the user through VR interface device 420. Different applications within which simulation engine 432 performs actions can be stored in applications database 434 residing in the memory of computer 430.

During a simulation, the cycle of action-presentment-reaction creates an interactive experience, which when coupled with haptic and other sensory feedback, can create an immersive experience with the look and feel of whatever environment is simulated.

Although described in terms of a virtual reality environment, in other embodiments the environment in which system 96 is implemented can be one of augmented, rather than virtual, reality. In different embodiments, the environment in which system 96 is implemented can be a simulated environment rendered by a simulator, such as a medical training simulator or a flight simulator. Presentment of a virtual or simulated environment need not be limited to sounds and images presented with a headset. In other embodiments, images can be conveyed on screens and sounds through speakers within a designated structure, including in single- or multi-person simulator or within the room of a building.

Computer 430 can be any type of computer, such as computer 312 illustrated in FIG. 3. Accordingly, the computer can comprise at least one processor 316, a memory 328, and a bus 318 over which data and control signals are exchanged between processor and memory, as well as other system components, including I/O interfaces 322. In various other embodiments, computer 430 can be an application-specific computer, such as a gaming console or a training simulator. In other embodiment mobile phone can be inserted into, or used in conjunction with, VR headset 410, the phone serving as computer 430 and providing electronic display 412.

Simulation engine 432 can be implemented in processor-executable code running on a general-purpose or application-specific computer. In other embodiments, simulation engine 432 can be implemented in dedicated, hardwired circuitry. In still other embodiments, the simulation engine 432 can be implemented in a combination of processor-executable code and dedicated, hardwired circuitry. Regardless, whether implemented in code or hardware, simulation engine 432 can, in other embodiments, be incorporated in a device such as a smartphone, which in turn can connect to the VR headset 410.

In a particular embodiment, system 96 includes a message-simulation interface 500 that, operatively, is interposed between simulation engine 432 and a communication device 436. As with the simulation engine 432, message-simulation interface 500 can be implemented in processor-executable code that runs on one or more processors of computer 430, in dedicated circuitry added to the computer's circuitry, or any combination thereof. Message-simulation interface 500 responds to a message received by communication device 436 communicatively coupled to computer 430. When a message is received for a user who is engaging in a simulation using VR headset 410, message-simulation interface 500 is capable of choosing an object within the simulated environment to use in notifying the user that the message has been received.

The behavior of the object, as it is presented by system 96 to the user in the context of the simulation, is correlated with the ambience of the simulation. The system can determine the urgency of the message and present the object behaving in a manner commensurate with the level of urgency.

For example, the user might be relaxing after work by engaging in a “day at the beach” simulation, wherein the environment simulates the user laying in a hammock between two coconut-laden palm trees near the surf on a beach. A first message arrives simply inquiring what the user is currently doing and soon thereafter a second message arrives regarding an urgent work-related matter. System 96 responds to the messages' arrivals by assessing the simulated environment in which the user is engaged and identifying objects in the user's immediate view, which in the present scenario is the view looking up through the tops of the palm trees toward the sky. The system can also identify objects not in the user's immediate view, yet recognized with other senses, such as the sound of waves crashing along the beach.

In this scenario, system 96 can leverage the expected behavior of a coconut on the palm tree, for example. Initially, the coconut could begin swaying in response to a sea breeze or could fall from the palm tree causing the user's view to change focus and look at the coconut on which is written “important message from the office” referring to the second message. The first message, having less urgency, could be notified by system 96 less intrusively by, for example, causing the waves just out of the user's view to pick up slightly with a message indicator appearing over a distant horizon.

In other scenarios, system 96 can introduce objects into the simulated environment. For example, in the “day at the beach,” objects having different degrees of obtrusiveness can be used such as billowing clouds rolling in, seagulls flying over, or a ship off in the distance blowing a fog horn.

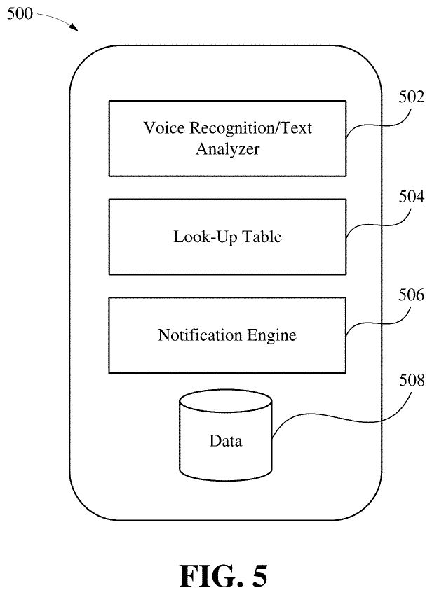

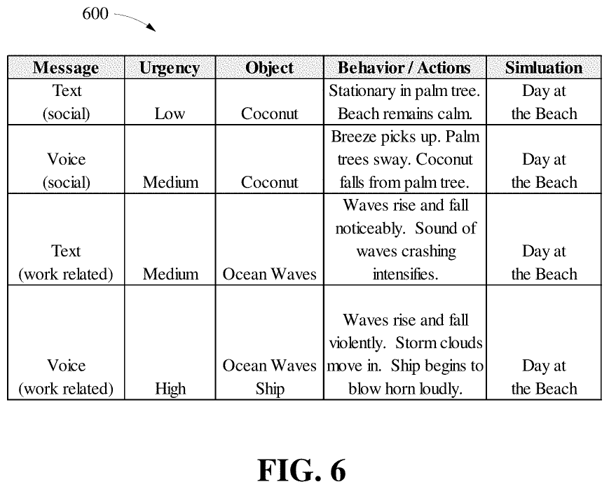

Referring now to FIG. 5, message-simulation interface tool 500 is depicted in greater detail. Interface tool 500 illustratively includes voice recognition/text analyzer 502, look-up table 504, notification engine 506, and data store 508. Voice recognition/text analyzer 502 can be used to identify attributes of an incoming message, such as the caller or sender and the words or text indicating the message topic. The look-up table 504 can be used to associate objects and their behaviors with received messages. FIG. 6 depicts look-up table 600 as but one example of a look-up table. Illustratively, look-up table 600 includes message type (e.g., work-related or social) and form (e.g., text or voice), urgency level, object, object behaviors and actions, and the specific simulation (e.g., day at the beach).

A unique look-up table can be generated for each type of simulation presented by the simulator in which system 96 is incorporated or with which system 96 is used. For example, the “day at the beach simulation” can correspond to objects such as palm trees, coconuts, waves, sea breeze, etc. Different objects can be associated with corresponding behaviors, such as swaying, falling, crashing, etc. Likewise, different scenarios can combine objects and behaviors. Different message types and corresponding urgency levels can be associated with the different behaviors that are fed to by the notification engine 506 to the simulation engine 432 for presenting a scenario-based notification to the user announcing arrival of a waiting message.

In a particular embodiment, information in the look-up table can be captured using Structure Query Language (SLQ) schema. The SLQ schema can indicate structured relations among database items. Accordingly, an SQL command can be sent to data store 508 to query the table and initiate an action based on the response.

Operatively, one or more objects and corresponding object behaviors are selected by voice recognition/text analyzer 502 based on the content of a received message. The selected objects and corresponding behaviors are fed to the notification engine 506. Objects and corresponding behaviors can be stored as data structures residing in data store 508 and selected by the notification engine 506 (e.g., using SQL schema). The data structures may include processor-executable instructions that are supplied to the simulation engine 432, which responds by generating with VR headset 410 images, video, and/or sounds in which the selected object behaves according to the instructions, such as the coconut falling from the palm tree with the words “important message from the office” inscribed on the coconut.

In certain embodiments of system 96, voice recognition/text analyzer 502 includes a tone analyzer (e.g., IBM Watson™ Tone Analyzer) and/or natural language understanding (NLU) processor for performing linguistic analyses of voice and/or textual data contained in the received message. The analyses can predict the tone and emotion of the message, which system 96 can use to predict an urgency level of the message. In a particular embodiment, system 96 can use machine learning to develop, train, and manage classifiers for classifying the urgency of messages and, based on the classifications, select objects and object behaviors for presenting message notifications.

Optionally, system 96 also can predict a user's dominant sense and select an object and behavior directed to that sense. For example, the user may have fallen asleep, in which event notification must rely on attracting the user's notice by stimulating another of the user's senses, such as auditory sense. Various embodiments can utilize different techniques for detecting when a user may have fallen asleep. In one embodiment, system 96 utilizes an optical tracker (e.g., video camera, not explicitly shown) that can be incorporated in the VR headset 410 and to which the message-simulation interface 500 can communicatively couple via computer 430. The optical tracker senses light (e.g., light in the infrared region of the spectrum) reflected from the user's eye and determines eye rotations based on changes in the reflections. System 96 can, for example, infer from optical tracking data that the user is asleep or otherwise no longer engaged with the visual aspect of simulation. Accordingly, system 96 can select an auditory-focused presentment rather than a visually oriented one. For example, if the system predicts that a user has fallen asleep while engaged in the “day at the beach simulation,” the system might generate sounds imitating the wind picking up and the waves crashing more forcefully on the shore. Thus, system 96 can also generate notification of a high-priority message be received by predicting the user's dominant sense and use a presentment oriented to that sense of the user.

The system 96 also can use a system timer to time whether the user as responded to a notification within a predetermined time. If not, the system can select another, more obtrusive object or behavior to announce again the arrival of a waiting message. The procedure can repeat iteratively, with each announcement being presented more emphatically than the previous one.

In simulating the action of the notifying object, the system can present an image associated with the ambience of the simulation, a sound associated with the ambience, a sent (e.g., using a scent spray device) associated with the ambience, or a tactile sensation associated with the ambience (e.g., using sensor-embedded gloves or other wearable devices for providing haptic feedback). Action of the notifying object can be presented using any combination of image, sound, scent, and/or tactile sensation associated with the ambience of the simulation.

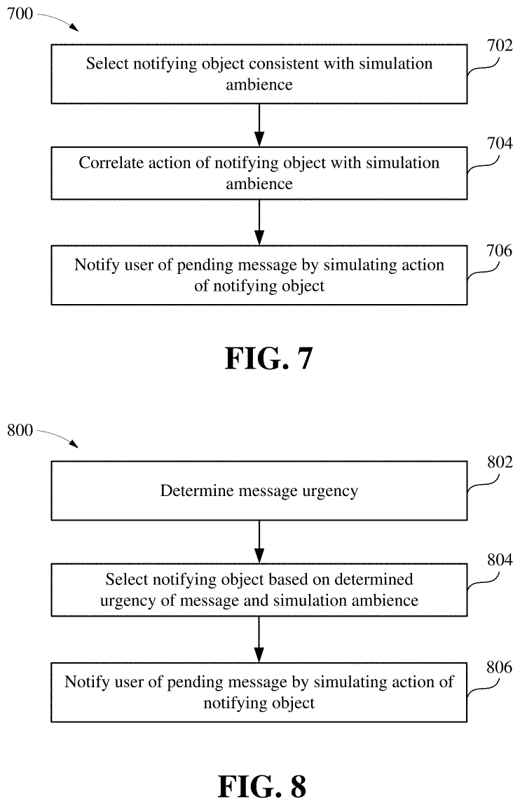

FIG. 7 is a flowchart of a method 700 of notifying a user engaged in a simulation that a message is waiting in accordance with one embodiment. Method 700 can be performed by a system the same or similar to the systems described in connection with FIGS. 1-6. The system can respond to the receipt of the message by indexing into a database specifying the ambience of the specific simulation in which the user is engaged and select a notifying object. Specifically, method 700 can begin with the arrival of a message directed to a user engaged in a simulation. At 702, a notifying object consistent with the ambience of the simulation is selected. The action of the notifying object for presenting the notification to the user is correlated with the ambience of the simulation at 704. The notifying object and object actions are simulated at 706 by the simulator. Optionally, the notifying object, or another object consistent with the ambience, can subsequently be used to present the content of the message to the user. In another embodiment, the notifying object or another object consistent with the ambience can notify the user by conveying all or a portion of the received message.

FIG. 8 is a flowchart of a method 800 of notifying a user engaged in a simulation that a message is waiting according to another embodiment. Method 800 also can be performed by a system the same or similar to the systems described in connection with FIGS. 1-6. The system can respond to the receipt of a message by indexing into a database specifying the ambience of the specific simulation and, based on the determined urgency of the message, select a notifying object that is consistent with the simulation ambience. Specifically, the method can begin with the system receiving a message directed to a user engaging in a simulation. At 802, the urgency of the message is determined. A notifying object consistent with the ambience is selected at 804 based on the determined urgency of the message. The simulated actions of the notifying object can also be selected based on the urgency of the message. At 806 the user is notified of the pending message by presenting the notifying object to the user during the simulation. Optionally, the notifying object, or another object consistent with the ambience, can subsequently be used to present the content of the message to the user. In another embodiment, the notifying object or another object consistent with the ambience can notify the user by conveying all or a portion of the received message.

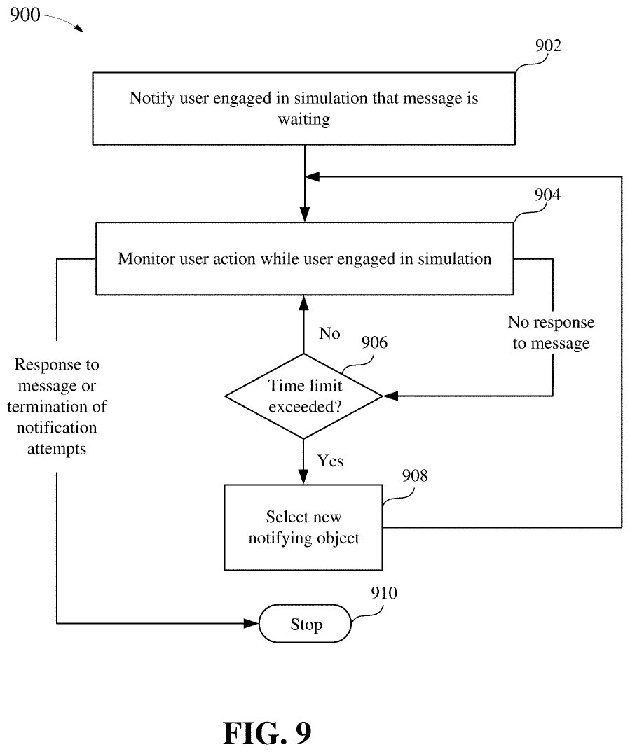

FIG. 9 is a flowchart of another aspect of a method 900 of notifying a user engaged in a simulation that a message is waiting according to still another embodiment. The method can be performed by a system the same or similar to the systems described in connection with FIGS. 1-6. The method can begin at 902 by notifying a user engaged in a simulation that a message is waiting. A notifying object consistent with the ambience of the simulation can be selected to present the notification while the user remains engaged in the simulation. The user's action while engaged in the simulation can be monitored at 904. If at 906 the user has not responded to the notification when a time limit is exceeded (or a timeout is reached terminating further notifications), then a new notifying object is selected at 908. The new notifying object can be purposely selected in terms of shape, structure, color, sound, and/or other effect to more starkly contrast with the simulated environment. Alternatively, in lieu of a new notifying object, the initial notifying object can be used, but the simulated actions of the object can be ones that draw greater attention to the object (e.g., a coconut that falls from, rather than merely sways with, a palm tree swaying in a sea breeze). The notifications can continue iteratively until either the user responds to a notification or further notifications are terminated.

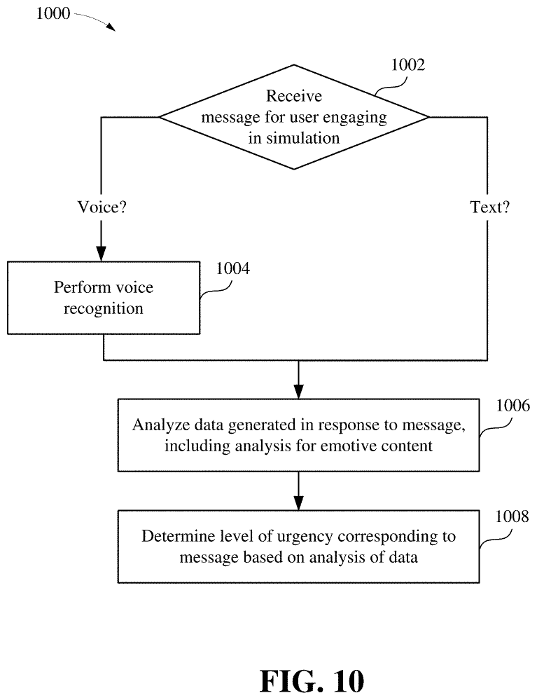

FIG. 10 is a flowchart of another aspect of a method 1000 of notifying a user engaged in a simulation that a message is waiting. The method can be performed by a system the same or similar to the systems described in connection with FIGS. 1-6. The method can begin at 1002 with the receipt of message directed to a user engaged in a simulation. Voice recognition of the message is performed at 1004 in the event that the message is a voice message received with a device communicatively coupled to a computer generating the simulation. At 1006, the data generated from the received message is analyzed, including for emotive content of the message. The analysis can be performed using a tone analyzer (e.g., IBM Watson™ Tone Analyzer) and/or natural language understanding (NLU) processor for performing linguistic analyses of voice and/or textual data contained in the received message. The analyses can predict the tone and emotion of the message. Based on the analysis, a level of urgency corresponding to the message is determined at 1008.

The methods, systems, and computer program products are described with reference to FIGS. 1-10. The figures are conceptual illustrations allowing for a full explanation of the present embodiments. The figures and examples presented below are not meant to be scope limiting, as other embodiments are possible by way of interchange of some or all of the described or illustrated elements. Moreover, where certain elements of the present embodiments can be partially or fully implemented using known components, only those portions of such known components that are necessary for an understanding of the present embodiments are described, and detailed descriptions of other portions of such known components are omitted so as not to obscure the embodiments. In the present specification, an embodiment showing a singular component should not necessarily be limiting with respect to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present embodiments encompass present and future known equivalents to the known components referred to herein by way of illustration.

The various methods described can be implemented, for example, in program code executable by a data processing system and stored on the computer-readable storage medium of a computer program product. The computer program product can include the computer-readable storage medium (or media) having computer-readable program instructions thereon for causing a processor to carry out aspects of the described embodiments.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments disclosed herein been presented for purposes of illustration and are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A method, comprising:
responsive to receiving a message for a user engaging in a computer-generated simulation, determining, using computer hardware, an urgency of the message;
notifying the user of the message using a simulated notifying object consistent with an ambience of the simulation and based on the urgency;
estimating a sense of awareness of the user; and
selecting of the simulated notifying object based on the estimated sense of awareness.

2. (canceled)

3. The method of claim 1, further comprising
simulating an action of the simulated notifying object based on the urgency.

4. The method of claim 3, wherein
the simulating of the action of the simulated notifying object comprises presenting at least one of
an image associated with the ambience;
a sound associated with the ambience;
a scent associated with the ambience of the simulation; and
tactile sensation associated with the ambience.

5. The method claim 4, further comprising
at least one of using a different simulated notifying object and simulating a different action if the user does not respond within a predetermined time to a prior presentment of the notifying object.

6. The method of claim 1, further comprising
introducing the simulated notifying object into the simulation if, at the time of the selecting, the simulated notifying object is not part of the simulation.

7. The method of claim 1, wherein
the urgency is determined based on at least one of a user definition and a natural language understanding method applied to the message.

8. A system, comprising:
a processor programmed to initiate executable operations including:
responsive to receiving a message for a user engaging in a computer-generated simulation, determining an urgency of the message;
notifying the user of the message using a simulated notifying object consistent with an ambience of the simulation and based on the urgency;
estimating a sense of awareness of the user; and
selecting of the simulated notifying object based on the estimated sense of awareness.

9. (canceled)

10. The system of claim 8, wherein
the processor is programmed to initiate executable operations further comprising
simulating an action of the simulated notifying object based on the urgency.

11. The system of claim 10, wherein
the simulating of the action of the simulated notifying object comprises presenting at least one of
an image associated with the ambience;
a sound associated with the ambience;
a scent associated with the ambience; and
tactile sensation associated with the ambience.

12. The system of claim 11, wherein
the processor is programmed to initiate executable operations further comprising
at least one of using a different simulated notifying object and simulating a different action if the user does not respond within a predetermined time to a prior presentment of the notifying object.

13. The system of claim 8, wherein
the urgency is determined based on at least one of a user definition and a natural language understanding method applied to the message.

14. A computer program product, comprising:
a computer readable storage medium having program code stored thereon, the program code executable by a data processing system to initiate operations including:
responsive to receiving a message for a user engaging in a computer-generated simulation, determining an urgency of the message;
notifying the user of the message using a simulated notifying object consistent with an ambience of the simulation and based on the urgency;
estimating a sense of awareness of the user; and
selecting of the simulated notifying object based on the estimated sense of awareness.

15. (canceled)

16. The computer program product of claim 14, wherein
the program code is executable by the data processing system to initiate operations further comprising
simulating an action of the simulated notifying object based on the urgency.

17. The computer program product of claim 16, wherein
simulating the action of the notifying object comprises presenting at least one of
an image associated with the ambience;
a sound associated with the ambience;
a scent associated with the ambience; and
tactile sensation associated with the ambience.

18. The computer program product of claim 17, wherein
the program code is executable by the data processing system to initiate operations further comprising
at least one of using a different simulated notifying object and simulating a different action if the user does not respond within a predetermined time to a prior presentment of the notifying object.

19. The computer program product of claim 14, wherein
the program code is executable by the data processing system to initiate operations further comprising
introducing the simulated notifying object into the simulation if, at the time of the selecting, the simulated notifying object is not part of the simulation.

20. The computer program product of claim 14, wherein
the urgency is determined based on at least one of a user definition and a natural language understanding method applied to the message.
